(19) United States
(12) Patent Application Publication
(10) Pub. No.: US 2007/0129865 A1
(43) Pub. Date: Jun. 7, 2007

(54) VEHICLE HEIGHT CONTROLLING SUSPENSION APPARATUS HAVING SIGNAL-FREEZE DETERMINING FUNCTION AND VEHICLE HEIGHT CONTROL METHOD THEREOF

(75) Inventor: Wan Il Kim, Osan-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MANDO CORPORATION, Seoul (KR)

(21) Appl. No.: 11/565,662

(22) Filed: Dec. 1, 2006

(30) Foreign Application Priority Data
Dec. 2, 2005 (KR) 10-2005-0116972

(51) Int. Cl. B60G 17/018

(52) U.S. Cl. 701/37; 280/5.5

(57) ABSTRACT

A vehicle height controlling suspension apparatus having a signal-freeze determining function includes a plurality of vehicle height sensors to measure the height of a vehicle. Vehicle height adjusting actuators are driven to adjust the height of the vehicle. An electronic control unit (ECU) is configured to perform adjustment of the height of the vehicle by the actuators by calculating a vehicle height variation value from vehicle height signals of the plurality of vehicle height sensors and compare the calculated vehicle height variation value with a reference value to determine whether the signals are frozen.

### BACKGROUND OF THE INVENTION

The present invention relates to a vehicle height controlling suspension apparatus having a signal-freeze determining function and a vehicle height control method thereof, and more particularly, to a vehicle height controlling suspension apparatus having a signal-freeze determining function and a vehicle height control method thereof, wherein the height of a vehicle is controlled by determining whether a signal from a vehicle height sensor is frozen, thereby securing handling stability of the vehicle and preventing an excessive operation of a suspension system.

Initially, a vehicle suspension apparatus was based on only the concept of simply supporting a vehicle body. However, it recently is being developed to improve ride comfort by maintaining vehicle height against the weight of a vehicle body and with respect to a road surface and absorbing shocks transmitted from the road surface to the vehicle body, and to improve handling stability of the vehicle by maintaining the vehicle body in an attitude suitable for driving.

Generally, damping force exhibits opposing properties in view of ride comfort and handling stability, and thus, there are many difficulties in determining the damping force. Accordingly, there have been recently conducted many studies on dynamic design and driving dynamics analysis in consideration of the ride comfort and handling stability of the suspension apparatus.

As a result of those studies, there has been developed a suspension apparatus capable of actively correcting changes in the attitude of a vehicle body depending on road surface conditions, driving conditions or vehicle conditions to improve driving performance, handling stability, and ride comfort of a vehicle.

A vehicle height controlling suspension apparatus has been developed in such a context. The vehicle height controlling suspension apparatus can maintain a vehicle body at a certain height depending on fluctuations of load and changes in a road surface and further may have a vehicle height varying function performed by a driver's simple operation and/or a speed-sensitive vehicle height changing function of changing vehicle height depending on changes in vehicle speed.

Various types of vehicle height controlling suspension apparatuses are being developed, implemented or studied. Among them, an air suspension apparatus for controlling vehicle height using changes in internal pressure of an air spring based on vehicle height information measured by vehicle height sensors has been widely known.

Such an air suspension apparatus is constructed such that vehicle height sensors are installed at least one of front and rear wheel sides of a vehicle and the height of the vehicle is controlled by driving air springs installed at respective wheels, based on signals received from the respective vehicle height sensors.

In the vehicle suspension apparatus provided with such vehicle height sensors, it is determined whether signals from the vehicle height sensors, which are affected by structural or electrical defects caused by external environments, are in a normal range, and the control of the height of the vehicle is stopped if the signals are out of the normal range. That is, cases where the control of the height of a vehicle is stopped include a short circuit of a power line, an open circuit, and a ground (GND) short circuit.

However, apart from the cases where normal signals are not outputted, such as a short circuit of a power line, an open circuit and a GND short circuit. if the vehicle height sensors are in a signal-freeze (fixed output) state due to the breakdown of the sensors in which they cannot output normal signals, it is difficult to determine the signal-freeze state. Therefore, the height of a vehicle is controlled even when the sensor signals are frozen, resulting in degradation of the stability of the vehicle.

For example, if the voltage level of a vehicle height sensor is in the range of 0V to 5V, a signal of 0V to 0.5V is outputted in case of a short circuit or a GND short circuit, a signal of 0.5V to 1.9V is outputted in a case where a signal from the sensor is out of the normal range, a signal of 1.9V to 3.1V is outputted in a case where the sensor operates normally, a signal of 3.1V to 4.5V is outputted in a case where a signal from the sensor is out of the normal range, and a signal of 4.5V to 5V is outputted in case of an open circuit or a short circuit of a power line.

Such voltage sections (0.5V to 1.9V and 3.1V to 4.5V) out of the normal range appear when the sensor mounted between the vehicle body and a vehicle axle deviates from displacement that may be physically caused by relative motions of the vehicle body and the vehicle axle.

Such voltage sections out of the normal range may occur if the sensor is damaged and stuck, a sensor mounting part (a fixing screw) is loosened and drooped down by gravity, or a rotating portion of the sensor does not move.

If a sensor value deviates from the normal signal range due to such reasons, it can be easily detected. However, if a sensor signal is frozen within the normal range (1.9V to 3.1V) and does not vary, it is difficult to determine whether the signal is normal.

That is, it is difficult to distinguish whether an output value of a vehicle height sensor is frozen due to the breakdown of the vehicle height sensor or an output value of the vehicle height sensor is frozen since the vehicle is actually maintained at a certain vehicle height.

Accordingly, even when a sensor signal is frozen within a normal range and does not vary, the vehicle suspension apparatus controls the height of a vehicle, resulting in a risk of the breakdown of a suspension system due to excessive use of the system.

### SUMMARY OF THE INVENTION

An embodiment of the present invention provides a vehicle height controlling suspension apparatus having a signal-freeze determining function and a vehicle height control method thereof, wherein the height of a vehicle is controlled by determining whether a signal from a vehicle height sensor is frozen, thereby improving stability of the vehicle and preventing the breakdown of a suspension system due to excessive use of the system.

In one embodiment, a vehicle height controlling suspension apparatus having a signal-freeze determining function includes a plurality of vehicle height sensors for measuring the height of a vehicle; vehicle height adjusting actuators driven for adjusting the height of the vehicle; and an electronic control unit (ECU) for performing adjustment of the height of the vehicle by the actuators by calculating a vehicle height variation value from vehicle height signals of the plurality of vehicle height sensors and comparing the calculated vehicle height variation value with a predetermined reference value to determine whether the signals are frozen.

The ECU may comprise a calculating section for calculating a maximum vehicle height variation value from the vehicle height signals of the plurality of vehicle height sensors for a predetermined time period; a suspect flag setting section for comparing the maximum vehicle height variation value calculated by the calculating section with the reference value and setting a state flag of a vehicle height sensor satisfying a predetermined reference condition to a suspect flag; a determination section for determining the vehicle height sensor satisfying the predetermined reference condition to be in a signal-freeze state if the number of sensors set to the suspect flag is not greater than a half of the total number of vehicle height sensors; an abnormal flag setting section for setting the state flag of the vehicle height sensor to an abnormal flag according to the determination of the determination section; and a vehicle height adjustment processing section for stopping vehicle height control of an actuator positioned to correspond to the vehicle height sensor if the state flag is set to the abnormal flag by the abnormal flag setting section.

The ECU may further comprise an alarm processing section for outputting a predetermined alarm signal if the state flag is set to the abnormal flag by the abnormal flag setting section.

The vehicle height adjustment processing section may output a predetermined alarm signal and stop the vehicle height control if the abnormal flag is set and initialized repeatedly as many as a predetermined number of times.

In another embodiment, a vehicle height control method of a vehicle height controlling suspension apparatus having a signal-freeze determining function includes the steps of receiving vehicle height signals from a plurality of vehicle height sensors for measuring the height of a vehicle; and performing vehicle height control by calculating a vehicle height variation value from the received vehicle height signals and comparing the calculated vehicle height variation value with a predetermined reference value to determine whether the signals are frozen.

The step of performing the vehicle height control may comprise the steps of calculating a maximum vehicle height variation value from the vehicle height signals of the plurality of vehicle height sensors for a predetermined period of time; comparing the calculated maximum vehicle height variation value with the reference value and setting a state flag of a vehicle height sensor satisfying a predetermined reference condition to a suspect flag; determining the vehicle height sensor satisfying the predetermined reference condition to be in a signal-freeze state if the number of sensors set to the suspect flag is not greater than a half of the total number of vehicle height sensors; setting the state flag of the vehicle height sensor to an abnormal flag according to the determination; and stopping vehicle height control of an actuator positioned to correspond to the vehicle height sensor if the state flag is set to the abnormal flag.

The step of performing the vehicle height control may further comprise the step of outputting a predetermined alarm signal if the state flag is set to the abnormal flag.

The step of stopping the vehicle height control may comprise the steps of outputting a predetermined alarm signal if the abnormal flag is set and initialized repeatedly as many as a predetermined number of times; and stopping the vehicle height control.

### BRIEF DESCRIPTION OF THE DRAWINGS

FIG. 1 is a diagram schematically showing a vehicle height controlling suspension apparatus having a signal-freeze determining function according to an embodiment of the present invention;

FIG. 2 is the block diagram specifically illustrating an ECU shown in FIG. 1; and

FIG. 3 is a flowchart illustrating a vehicle height control method of the vehicle height controlling suspension apparatus having the signal-freeze determining function according to an embodiment of the present invention.

### DETAILED DESCRIPTION OF THE INVENTION

FIG. 1 is a diagram schematically showing a vehicle height controlling suspension apparatus having a signal-freeze determining function according to an embodiment of the present invention.

As shown in FIG. 1, the vehicle height controlling suspension apparatus having a signal-freeze determining function according to the present embodiment comprises a plurality of vehicle height sensors 12L, 12R, 22L and 22R for measuring the height of a vehicle, a plurality of vehicle height adjusting actuators 10L, 12R, 20L and 20R driven for adjusting the height of the vehicle, and an ECU 30 for controlling the height of the vehicle adjusted by the actuators according to signals received from the plurality of vehicle height sensors 12L, 12R, 22L and 22R.

The vehicle height sensors include front wheel-side sensors 12L and 12R installed in the vicinity of front left and right wheels FL and FR, and rear wheel-side sensors 22L and 22R installed in the vicinity of rear left and right wheels RL and RR.

In this embodiment, the vehicle height sensors 12L, 12R, 22L and 22R detect relative distances between a vehicle body and vehicle axles (i.e., vehicle height), and the most typical one in which two rotating levers are respectively mounted on the vehicle body and the vehicle axle to sense a distance therebetween by detecting a relative angle of the two levers with respect to linear displacement are employed as the vehicle height sensor.

The actuators 10L, 10R, 20L and 20R (hereinafter, referred to as “air springs”) are also positioned to correspond respectively to the aforementioned vehicle height sensors 12L, 12R, 22L and 22R. Such air springs include front wheel-side left and right air springs 10L and 10R, and rear wheel-side left and right air springs 20L and 20R.

The ECU 30 receives vehicle height signals from the vehicle height sensors 12L, 12R, 22L, and 22R at the positions of respective wheels and substantially controls the height of the vehicle based on the signals.

In the embodiment of the present invention, the ECU 30 controls the front wheel-side air springs 10L and 10R and rear wheel-side air springs 20L and 20R based on the vehicle height signals received from the respective vehicle height sensors.

The ECU 30 drives, with a certain control value, a compressor (not shown) and a pneumatic circuit (not shown) including the compressor.

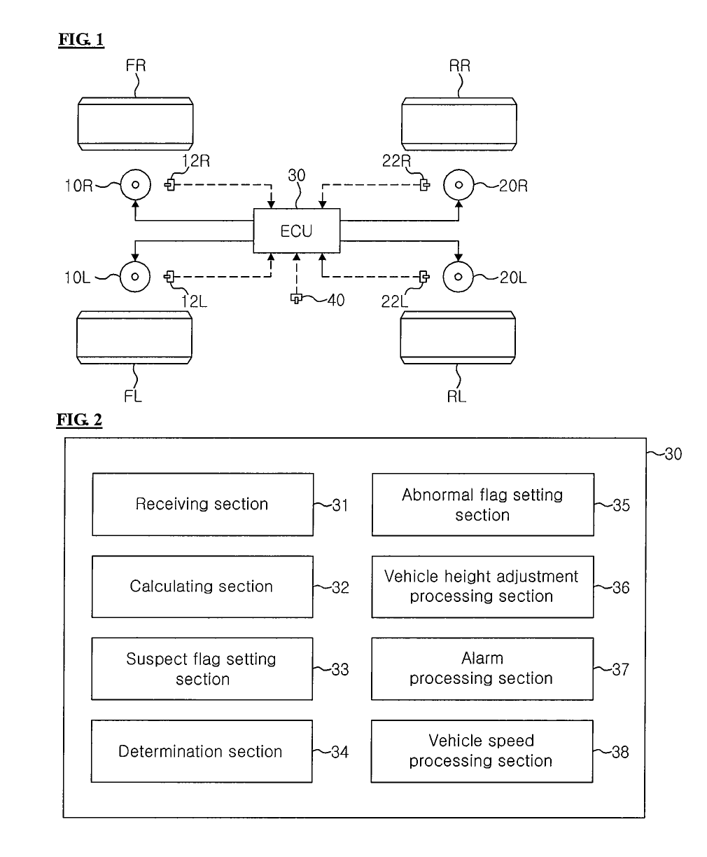

According to the present invention, the ECU 30 is constructed to control the height of the vehicle by comparing a vehicle height variation value calculated from the vehicle height signals received from the plurality of vehicle height sensors 12L, 12R, 22L and 22R with a predetermined reference value, and determining whether the sensor signals are frozen. The configuration of the ECU 30 will be described below with reference to FIG. 2.

Referring to FIG. 2, the ECU 30 in this embodiment determines from the freeze of a sensor signal that a sensor cannot function any more and generates a fixed output, and then stops the control of the height of the vehicle. The ECU comprises a receiving section 31 for receiving vehicle height signals, a calculating section 32 for calculating a vehicle height variation value from the received vehicle height signals, a suspect flag setting section 33 for comparing the vehicle height variation value with a predetermined reference value and setting a state flag of a sensor to a suspect flag according to whether a predetermined condition is satisfied, a determination section 34 for determining a signal-freeze state, an abnormal flag setting section 35 for setting the state flag to an abnormal flag according to the determination, a vehicle height adjustment processing section 36 for stopping vehicle height control of an air spring including a wheel on which a sensor with a state flag set to the abnormal flag is mounted, an alarm processing section 37 for notifying the breakdown of a vehicle height sensor, and a vehicle speed processing section 38 for determining whether the vehicle is in a driving state.

At this time, in addition to the control of the vehicle height of the suspension apparatus, the ECU can perform overall control on the suspension apparatus and shock absorbers, and further participate in controlling other systems of the vehicle (for example, a steering system and/or a braking system). However, since the other control is not directly related to the subject matter of the present invention, detailed descriptions thereof will be omitted.

The receiving section 31 receives vehicle height signals from the two vehicle height sensors 12L and 12R on the side of the front wheels FL and FR, and the two vehicle height sensors 22L and 22R on the side of the rear wheels RL and RR, and transmits the signals to the calculating section 32.

The calculating section 32 calculates a maximum vehicle height variation value from the respective vehicle height signals received by the receiving section 31 for a predetermined period of time (e.g., one minute), using the following equation 1:
ΔHₗ=maxHᵢ−minHᵢ,
i=1, . . . ,4 (1)

If the maximum vehicle height variation value calculated by the calculating section 32 is smaller than a predetermined reference value, the suspect flag setting section 33 sets a state flag of a vehicle height sensor of the vehicle height sensors that satisfies a predetermined reference condition, to a suspect flag.

If the number of sensors, which are set to the suspect flag by the suspect flag setting section 33, is smaller than a half of the total number of vehicle height sensors (i.e., two or less among the four vehicle height sensors), the determination section 34 determines the vehicle height sensor that satisfies the predetermined reference condition to be in a signal-freeze state.

For example, if the state flag of the vehicle height sensor 12L on the side of the front wheels FL and FR is set to a suspect flag, or the state flag of the vehicle height sensor 12L on the side of the front wheels FL and FR is set to a suspect flag and the state flag of the vehicle height sensor 22L on the side of the rear wheels RL and RR is set to a suspect flag, the vehicle height sensor are determined to be in a signal-freeze state (i.e., an abnormal state).

If the vehicle height sensor is determined to be in an abnormal state as such, the abnormal flag setting section 35 sets the state flag of the vehicle height sensor to an abnormal flag.

If the state flag is set to an abnormal flag, the vehicle height adjustment processing section 36 stops vehicle height control of an air spring including a wheel on which the vehicle height sensor is mounted. Here, although the present embodiment has been described in connection with the case where the vehicle height control of an air spring positioned to correspond to the sensor is stopped, it is also possible to stop vehicle height control of an air spring for a wheel in which the state flag of the vehicle height sensor is set to an abnormal flag.

In addition, if the state flag of the vehicle height sensor is set to an abnormal flag and initialized repeatedly as many as a predetermined number of times, the vehicle height adjustment processing section 36 stops the control of the height of the vehicle. That is, the vehicle height adjustment processing section 36 determines the sensor to be broken down and does not any more perform vehicle height adjustment according to a vehicle height signal from the vehicle height sensor.

If the state flag of the vehicle height sensor is set to an abnormal flag, the alarm processing section 37 outputs a predetermined alarm signal. At this time, it is preferred that a user be notified of the breakdown of the sensor through a warning lamp.

In addition, even when the state flag of the vehicle height sensor is set to an abnormal flag and initialized repeatedly as many as a predetermined number of times, the alarm processing section 37 also outputs an alarm signal through the warning lamp. Accordingly, the user can easily notice the breakdown of the vehicle height sensor.

The vehicle speed processing section 38 determines whether the vehicle is in a driving state according to whether the speed of the vehicle measured by a vehicle speed sensor 40 for measuring the speed of a vehicle is not less than a predetermined speed (e.g., 30 kph).

At this time, if the speed of the vehicle measured by the vehicle speed sensor 40 is less than a predetermined speed (e.g., 30 kph), the vehicle is determined not to be in a driving state. This case occurs when state flags of three or four vehicle height sensors are set to a suspect flag by the suspect flag setting section 33.

In this manner, it is determined whether a signal from a vehicle height sensor is frozen, so that the height of the vehicle is controlled, thereby securing the stability of the vehicle.

The vehicle height control method of the vehicle height controlling suspension apparatus having a signal-freeze determining function constructed as such will be described below.

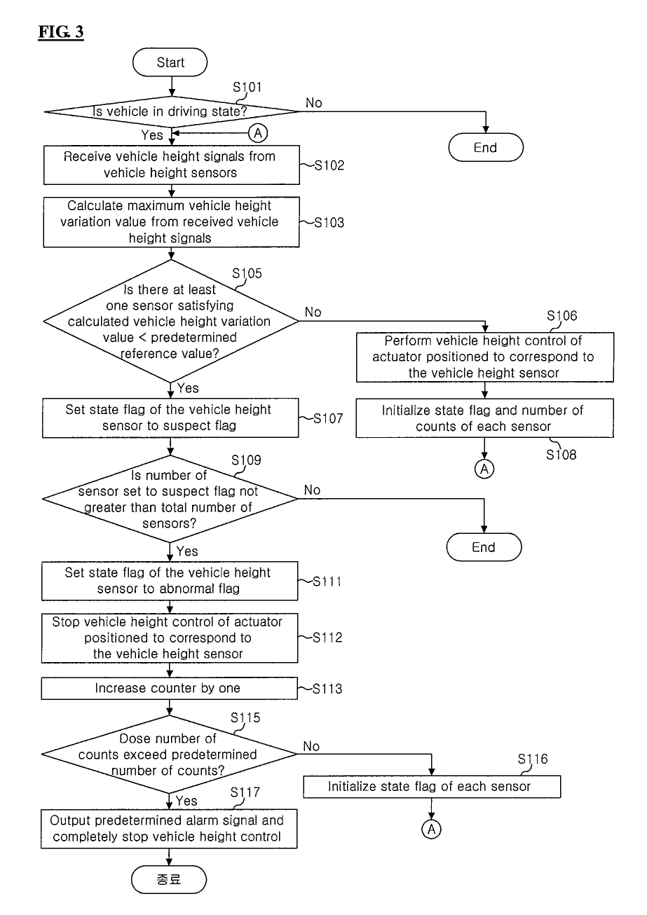

FIG. 3 is a flowchart illustrating a vehicle height control method of the vehicle height controlling suspension apparatus having the signal-freeze determining function according to an embodiment of the present invention.

The vehicle speed processing section 38 of the ECU 30 determines whether the vehicle is in a driving state (S101). That is, it determines whether the speed of the vehicle is not less than a predetermined speed (e.g., 30 kph).

If it is determined in step S101 that the vehicle is not in a driving state, the ECU terminates the process.

If it is determined in step S101 that the vehicle is in a driving state, the receiving section 31 of the ECU 30 receives vehicle height signals from the plurality of vehicle height sensors 12L, 12R, 22L and 22R installed in the vehicle (S102).

Then, the calculating section 32 of the ECU 30 calculates a maximum vehicle height variation value for each of the sensors from the vehicle height signals received for a predetermined period of time (S103).

Next, the suspect flag setting section 33 of the ECU 30 determines whether there is at least one sensor in which the calculated maximum vehicle height variation value is smaller than a predetermined reference value (S105).

If it is determined in step S105 that there is no sensor in which the calculated maximum vehicle height variation value is smaller than a predetermined reference value, the vehicle height adjustment processing section 36 of the ECU 30 performs vehicle height adjustment of an actuator positioned to correspond to the vehicle height sensor (S106).

Next, the vehicle height adjustment processing section 36 initializes the state flag and the number of counts of each sensor (S108) and proceeds to the process of step S101 to receive vehicle height signals.

If it is determined in step S105 that there is at least one sensor in which the calculated maximum vehicle height variation value is smaller than a predetermined reference value, the suspect flag setting section 33 sets the state flag of the vehicle height sensor to a suspect flag (S107).

Next, the determination section 34 of the ECU 30 determines whether the number of sensors having a suspect flag set by the suspect flag setting section 33 is not greater than a half of the total number of vehicle height sensors (S109). That is, if there are four vehicle height sensors, it is determined whether state flags of two or less vehicle height sensors are set to a suspect flag.

Here, if the number of sensors having the suspect flag is not greater than a half of the total number of vehicle height sensors, the determination section 34 determines that the vehicle height sensor(s) is(are) in a signal-freeze state. If the number of sensors having the suspect flag is three or four, the determination section determines that the vehicle is in a stationary state.

If it is determined in step S109 that the number of sensors having the suspect flag set by the suspect flag setting section is greater than a half of the total number of vehicle height sensors, i.e., if state flags of three or four vehicle height sensors are set to a suspect flag, the ECU 30 terminates the process.

The case where the state flags of three or four vehicle height sensors are set to a suspect flag occurs when the vehicle is in a stationary state.

If it is determined in step S109 that the number of sensors having the suspect flag set by the suspect flag setting section is not greater than a half of the total number of vehicle height sensors, i.e., if the state flags of one or two vehicle height sensors are set to a suspect flag, the abnormal flag setting section 35 of the ECU 30 sets the state flag of the vehicle height sensor to an abnormal flag (S111).

Then, the vehicle height adjustment processing section 36 temporarily stops vehicle height adjustment of an actuator positioned to correspond to the vehicle height sensor (S112). At this time, it is also possible to temporarily stop vehicle height control of the actuator.

Next, the vehicle height adjustment processing section 36 increases the number of counts by one (S113).

Then, the vehicle height adjustment processing section 36 determines whether the number of counts exceeds a predetermined number of counts (S115).

If it is determined in step S115 that the number of counts does not exceed a predetermined number of counts, i.e., if setting of the state flag to an abnormal flag and initialization of the state flag are not repeated as many as a predetermined number of times, the vehicle height adjustment processing section 36 initializes the state flag of each sensor (S116) and proceeds to the process of step S101.

If it is determined in step S115 the number of counts exceeds a predetermined number of counts, i.e., if setting of the state flag to an abnormal flag and initialization of the state flag are repeated as many as a predetermined number of times, the vehicle height adjustment processing section 36 outputs an alarm signal predetermined by the alarm processing section 37 and completely stops the vehicle height control (S117).

Although this embodiment has been described in connection with the case where vehicle height control is completely stopped if the state flag of the vehicle height sensor is set to an abnormal flag and initialized repeatedly as many as a predetermined number of times, the present invention is not limited thereto. Even when the vehicle height control is stopped and resumed repeatedly as many as a predetermined number of times, the vehicle height control may be completely stopped.

In this manner, the height of the vehicle is controlled to improve the stability of the vehicle, and the breakdown of a sensor is identified to prevent an excessive operation of the suspension system, thereby preventing the breakdown of the system.

According to the present invention described above, there is an advantage in that the height of a vehicle is controlled by determining a signal-freeze state of a vehicle height sensor, thereby improving the stability of the vehicle.

Further, according to the present invention described above, there are advantages in that the breakdown of a corresponding vehicle height sensor is identified so that an excessive operation of a suspension system can be prevented and thence the breakdown of the system can be prevented.

Moreover, according to the present invention described above, there are advantages in that a driver is notified of the breakdown of a vehicle height sensor, so that the driver can easily notice the breakdown of the vehicle height sensor and the worst dangerous situation can be prevented in advance.

The present invention is not limited to the aforementioned embodiments, and various changes and modifications can be made thereto by those skilled in the art. The various changes and modifications fall within the spirit and scope of the present invention defined by the appended claims.

What is claimed is:

1. A vehicle height controlling suspension apparatus having a signal-freeze determining function, the apparatus comprising:
a plurality of vehicle height sensors to measure the height of a vehicle;
vehicle height adjusting actuators driven to adjust the height of the vehicle; and
an electronic control unit (ECU) to perform adjustment of the height of the vehicle by the actuators by calculating a vehicle height variation value from vehicle height signals of the plurality of vehicle height sensors and compare the calculated vehicle height variation value with a reference value to determine whether the signals are frozen.

2. The apparatus as claimed in claim 1, wherein the ECU comprises:
a calculating section to calculate a maximum vehicle height variation value from the vehicle height signals of the plurality of vehicle height sensors for a given time period;
a suspect flag setting section to compare the maximum vehicle height variation value calculated by the calculating section with the reference value and set a state flag of a vehicle height sensor satisfying a reference condition to a suspect flag;
a determination section to determine the vehicle height sensor satisfying the reference condition to be in a signal-freeze state if the number of sensors set to the suspect flag is not greater than a half of the total number of vehicle height sensors;
an abnormal flag setting section to set the state flag of the vehicle height sensor to an abnormal flag according to the determination of the determination section; and
a vehicle height adjustment processing section to stop vehicle height control of an actuator positioned to correspond to the vehicle height sensor if the state flag is set to the abnormal flag by the abnormal flag setting section.

3. The apparatus as claimed in claim 2, wherein the ECU further comprises:
an alarm processing section to output a alarm signal if the state flag is set to the abnormal flag by the abnormal flag setting section.

4. The apparatus as claimed in claim 2, wherein the vehicle height adjustment processing section outputs a alarm signal and stops the vehicle height control if the abnormal flag is set and initialized repeatedly as many as a given number of times.

5. A vehicle height control method of a vehicle height controlling suspension apparatus having a signal-freeze determining function, the method comprising:
receiving vehicle height signals from a plurality of vehicle height sensors for measuring the height of a vehicle;
calculating a maximum vehicle height variation value from the vehicle height signals of the plurality of vehicle height sensors for a period of time; comparing the calculated maximum vehicle height variation value with the reference value and setting a state flag of a vehicle height sensor satisfying a reference condition to a suspect flag;
determining the vehicle height sensor satisfying the reference condition to be in a signal-freeze state if the number of sensors set to the suspect flag is not greater than a half of the total number of vehicle height sensors;
setting the state flag of the vehicle height sensor to an abnormal flag according to the determination; and
stopping vehicle height control of an actuator positioned to correspond to the vehicle height sensor if the state flag is set to the abnormal flag.

6. The method as claimed in claim 5, further comprising:
outputting a alarm signal if the state flag is set to the abnormal flag.

7. The method as claimed in claim 5, wherein the stopping step comprises:
outputting a alarm signal if the abnormal flag is set and initialized repeatedly a given number of times; and
stopping the vehicle height control.
